(19) United States
(12) Patent Application Publication
(10) Pub. No.: US 2007/0042012 A1
(43) Pub. Date: Feb. 22, 2007

(54) Game attracting substance and a method for applying

(76) Inventors: John Edward Ambrose JR., Severna Park, MD (US); John Edward Ambrose SR., Severna Park, MD (US)

Correspondence Address: Walter A. Reiter, III, 170 West Street, Annapolis, MD, 21401, US

(21) Appl. No.: 11/205,468

(22) Filed: Aug. 18, 2005

(51) Int. Cl. A01N 25/00

(52) U.S. Cl. 424/405; 43/1

(57) ABSTRACT

A Game Attracting Substance and a Method for Applying such substance comprised of a container, a solution of game attractant scent in a non-liquid sprayable foam or gel and a release mechanism whereby the contents of the container, the non-liquid foam or get containing the game attracting scent solution can be applied to a substrate. The same attracting substance is formulated such that a non-liquid three-dimensional mound of such substance can be applied to the top or underside of a horizontal substrate or a vertical substrate and thus be protected from environmental elements and yet exposed to air currents such as to effect disbursal of the scent. The device and the method of application solve problems existing with the present state of the art in that the scent containing medium as applied to the substrate is completely free of contamination by the hunter in that the hunter never comes into contact with the scent containing medium. Furthermore the method of use eliminates any litter or other object being left at the hunt site.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

The invention is in the field of game attracting scent substance and a method of applying such substance to a substrate at a hunt site. The invention permits the hunter to apply a game-attracting scent to a substrate at a hunt site well before the intended time within which the hunter anticipates the game will be attracted to the scent at a hunt site. The scent is carried in a medium that delays and prolongs the period of time within which the scent remains volatile and thus creates a long lasting attractant scent at a hunt site. The medium is also of a nature that permits the scent to be applied to a tree, rock, ground or other substrate in a manner which prevents the scent carrying medium from dispersing rapidly into the ground or atmosphere and thereby losing its attracting properties. The medium of the scent containing substance further permits the hunter to limit contamination of the site and the scent dispensing medium with the hunter's own scent and thereby increases the effectiveness of the game attracting scent. The method of applying the game attracting scent medium also eliminates contamination of a hunt site with either the container of the scent medium or the scent of such container.

2. Background of the Invention

Hunters have been since before recorded history employed various methods and techniques to lure game within range of the various tools and weapons employed by hunters over the ages to provide sustenance and sport. Animal urine or urine of the intended game is a well known game attractant. It is well known in the art that game, such as deer, are attracted to the scent of deer urine. It is well known that a male deer is particularly attracted to urine of a female deer. It is also well known in the art that a hunter will disperse deer urine in an area into which the hunter desires to attract the quarry and thereafter position him or herself in such a way as to effect capture of the game either permanently, temporarily or photographically. The preferred method of creating such an enticement is for the hunter to collect or obtain a container of deer urine and to dribble or pour the deer urine on the ground, a rock or a tree and to then retreat to the tree stand or blind and to wait for the quarry. Other methods entail the application of the urine to various materials such as cotton wadding. Such items are then placed by the hunter at the hunt site. Other methods entail the disbursal of the scent by the hunter leaving at the hunt site a spray dispenser which the hunter activates and then retreats from to the tree stand or blind to wait for the game. Such dispenser does not eliminate the problems caused by leaving the container at the hunt site. These problems include the hunter's scent that remains on the dispenser which necessarily must remain at the hunt site, the scent associated with the dispenser itself and the litter problem created by the un-retrieved scent dispenser.

The present invention overcomes the shortcomings and problems with the present state of the art and improves upon the delivery of scent to the hunt area.

U.S. Pat. No. 6,685,929 describes a non-liquid, non-gel scent lure for hunting comprised of animal urine and a thickening agent. The present invention solves a problem inherent in this prior art in that the present invention provides a means whereby the scent dispensing medium is applied to the hunt site in a manner that does not overly contaminate the site with the repellant scent of the hunter and the repellant scent of the scent container.

U.S. Pat. No. 6,648,239 describes a device for dispensing animal scents comprised of a cylindrical outer housing, an inner assembly of an absorbent wick for saturation with an attractant. The inner assembly is slidable in and out of the outer housing such that when in the slid out position, the absorbent wick is exposed to air currents. The present invention overcomes the dual shortcomings of this prior art. The present invention does not require the hunter to leave any non-degradable, durable object at the hunt site. Leaving such items at the hunt site has the disadvantage of littering the hunt site, leaving an object contaminated with the repellant hunter scent from the hunter's handling of the object and the repellant scent of the container itself The present invention overcomes all of those limitations of the prior art.

U.S. Pat. No. 6,592,104 describes a scent dispensing method comprised of a cylindrical outer housing containing an inner scent containing housing and a battery powered fan. This prior art presents the shortcomings of any scent dispenser left at the site but with the added hazard of the hunter, through inadvertence or by intention, abandoning a battery powered device at the hunt site with the environmental hazard presented by the discarded battery. The present invention leaves no detritus behind, does not overly contaminate the hunt site with the scent of the hunter lingering on the device or the scent of the device itself The present invention leaves only the uncontaminated and disbursable and degradable scent disbursing medium.

U.S. Pat. No. 6,550,689 describes an animal scent disbursing apparatus and method of use comprised of a staff, a housing unit, a liquid absorbing dragging material and a container of scent. The method of use is that as the staff is pressed onto the ground the action triggers a spraying device that sprays the scent onto the dragging material. The present invention overcomes the inherent shortcoming of this invention presented by the repellant scent of the hunter being disbursed along with the attractant scent and the ephemeral scent painted along the path of the hunter operating the scent dispensing staff. Furthermore, the scent applied to the path does not attract the game to a single spot within the range of the hunter's blind or stand.

U.S. Pat. No. 6,460,487 describes a scent dispenser for a deer repellant device comprised of a dispenser that is capable of disbursing an attractant scent and, upon a deer coming into contact with the dispenser, delivering an electric shock to the animal. The invention presents the same shortcomings of the prior art in that the site is contaminated by the dispenser and the repellant scent of the person installing the device lingers with the device. Furthermore, the scent dispenser disburses the attractant scent away from the device which delivers the intended electric shock, frustrating the operation of the invention.

### SUMMARY OF THE INVENTION

The present invention relates to an improved scent dispensing medium and a means for delivering the improved scent dispensing medium to the hunt site in a manner which eliminates many of the problems presented by the existing state of the art.

Game is both attracted to and cautioned to remain from an area by the scent existant at such site. A particular scent will attract game while another scent will repel game or will warn game to stay away from an area. The hunter desiring to lay a scent to attract game to an area is faced with the problem of how to deliver the attracting scent to the area without at the same time unintentionally delivering to the area a scent which will repel or warn the game away from the hunt site. The hunter carries a repellant scent and leaves a trail of such scent in his or her wake. An object foreign to the hunt site, such as a container or housing of man-made material also carries a repellant scent. The hunters repellant scent will linger with and be disbursed from any object that the hunter has handled, such as a container or housing of scent disburser.

The state of the art presently addresses only the former problem, how to deliver the attracting scent, without addressing the later problem, how to deliver the scent without introducing the repulsive scent of the hunter.

An inherent nature of scent is that it disperses and fades over time. The scent of a hunter passing through an area in the afternoon will be a strong warning to game encountering that scent in the evening but not a strong warning to game passing that way the next morning. The technique, known in the art, of dispensing urine from a container onto the hunt site has the disadvantage of being inseparably linked to the scent of the hunter doing the dispensing. Furthermore, the urine so dispensed will fade quickly by passing into the ground or by the natural dispersal of the scent over time. Therefore, the attractant and repellent are applied contemporaneously and are thus not effective.

To overcome the problem of rapid dispersal of the scent disbursed as urine poured onto the hunt site various slow dispersal solutions were developed. All of these solutions however still present the problem of the repellant scent of the hunter and many also present the lingering repellant scent of the container or housing itself and the scent of the hunter attached to the container or housing by action of the hunter's manipulation of the container or housing. These devices being in one embodiment an absorbent material infused with urine are utilized by the hunter placing the material at the hunt site. The hunter is, in addition to leaving the scent infused material, leaving an object which the hunter has handled. By handling the object, the hunter is leaving some of the hunter's repellant scent along with the repellant scent of the item not normally occurring at the hunt site, specifically the absorbent material and whatever materials are attached thereto to permit the suspension of the material such as a hook or loop. These inventions present the further undesirable effect of the highly likely event that such materials will not be retrieved by the hunter at the conclusion of the hunt and thereby contribute to litter in hunting areas. Such activity not only being contrary to law also presents a hazard to wildlife which might be compelled to ingest such materials and further presents an aesthetic problem which detracts from enjoyment of such hunting areas and might jeopardize hunter access to such areas in response.

The present invention overcomes the problems and draw backs of the present state of the art and presents an improved scent delivery mechanism. The present invention allows the hunter to deliver a slow, time released disbursal of attracting scent without the necessity for the hunter to leave with the disbursant the repellant scent of the hunter, the repellant scent of the scent disburser or the litter associated with the scent disburser.

### DESCRIPTION OF THE SEVERAL VIEWS OF THE DRAWINGS

The foregoing and other objects, aspects, and advantages will be better understood from the following detailed description of preferred embodiments of the invention with reference to the drawings, in which:

FIG. 1 is a perspective view of the invention showing the container “A”, the scent containing medium disbursal tube “B”, and the scent containing medium release button “C”.

FIG. 2 is a perspective view of the invention shown in representative by a hunter. The scent disbursing medium “D” is shown as applied to a suitable existing surface at a hunt site.

### DETAILED DESCRIPTION OF THE INVENTION:

The invention is a game scent medium and disbursal device that allows the hunter to spread a game attractant in a resilient and non-contaminated fashion on objects, such as the ground, a tree, rock or other substrate, at a hunting site. The invention solves problems presented by the existing state of the art and delivers a scent attraction superior to the medium and devices presently available.

The present invention relates to a scented liquid suspended in non-liquid form and contained in a container. The scent containing medium is dispensed from the container by depressing the release button such that the contents, stored under pressure are dispensed from the disbursal tube onto the substrate of the hunter's choosing. The scent containing medium is stored under pressure and in such form as to when released be disbursed in a non-liquid foam or gel form. The foam or gel form has the feature of being adherent to the substrate regardless of the angle of the substrate. The foam or gel is capable of being applied to and adhering to the horizontal, vertical side or underside of a rock or tree or the underside of a branch or overhanging rock. Such feature allows the scent containing medium to be placed at a hunt site, exposed to air currents but sheltered somewhat from rain or other elements which would rapidly disburse the scent and scent containing medium. Scent containing medium are susceptible to rapid disbursal should they be exposed to water or falling rain. The advantage of the scent containing medium having the adherent feature of the foam or gel of the present invention is that the scent containing material can be applied to a hunting site in a manner that protects the scent containing medium from rain and water.

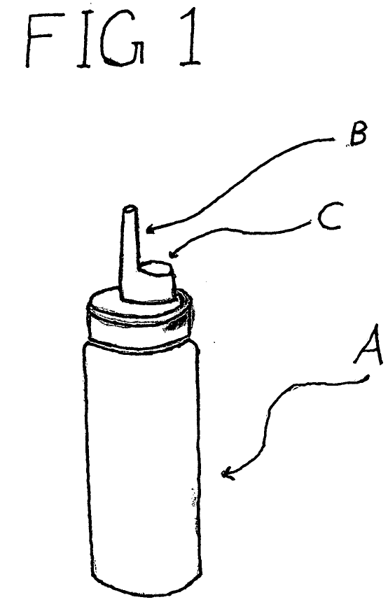

As set out in FIG. 1, the invention is comprised of a scent containing medium in a container. The scent containing medium is capable of being dispensed from the container by activation of the scent containing medium release button. The contents of the container are comprised of the game attractant scent and the medium to form the scent containing medium and formulated in a manner that is well known in the industry and widely used for delivery of shaving creams and gels, cleaning solvents, lubricants and other liquids or materials. The contents of the container are maintained under pressure or pressurized before and to effect delivery of the scent containing medium by depressing the scent containing medium release button. Upon such activation of the scent containing medium release button, an amount of foam or gel scent containing medium is dispensed through the disbursal tube and onto the substrate of the hunter's choosing.

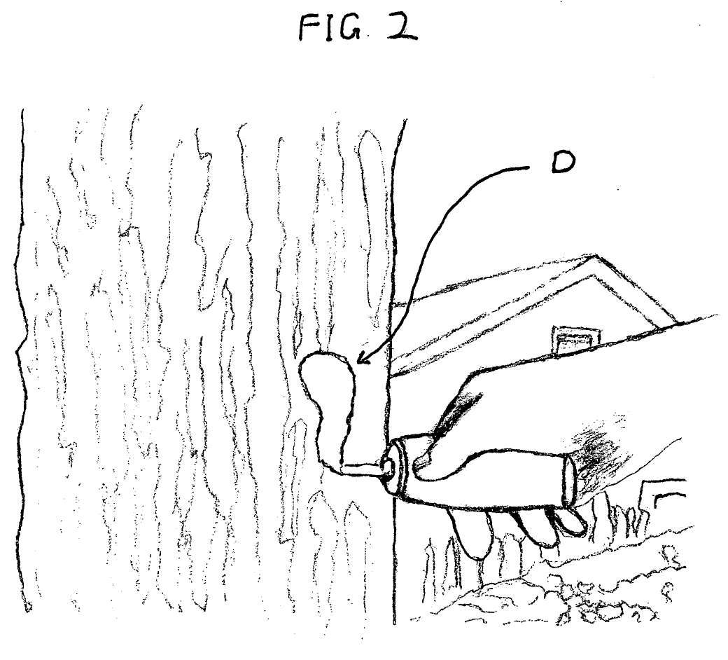

As set out in FIG. 2, the scent containing medium is applied to the selected substrate without the hunter ever coming into contact with the substrate or the scent containing medium thus a pure attractant scent, free of hunter contaminate is applied to the substrate leaving the area as free of repellant hunter scent as possible. Furthermore, the invention is then removed by the hunter from the hunt site eliminating further or prolonged contamination of the site by either the scent of the container or the litter of the container.

As set out in FIG. 2 the scent containing medium is applied as a lump, mound or pile adherent to the substrate. The feature of the invention that the medium has such density and adherent quality affords several advantages and improvements over the present state of the art. The adherent quality of the scent containing medium allows it to be applied in a manner that protects the scent containing medium from dissolution by rain or other elements. The adherent quality permits the scent containing medium to be applied in such a manner that the scent can be disbursed by air currents existing around the area of the application. The density of the scent containing medium allows the scent containing medium to be applied in a three dimensional lump, mound or pile. The scent is disbursed into the air by contact between the surface of the lump, mound or pile and the air currents.

I claim:

1. A game attracting scent medium and method of applying said game attracting scent medium to a substrate at a hunt site comprised of a container, a scent containing medium disbursal tube, and a scent containing medium release button.

2. The game attracting scent medium of claim 1 further comprised of a non-liquid gel or foam of such viscosity and adhesiveness as being capable of forming a three dimensional shape and adhering to vertical or inverted surfaces.

3. The method of applying said game attracting scent medium of claim 1 comprised of depressing said scent containing medium release button to release said game attracting scent medium through said scent containing medium disbursal tube onto said substrate at a hunt site.
